(19) United States
(12) Patent Application Publication
(10) Pub. No.: US 2010/0194578 A1
(43) Pub. Date: Aug. 5, 2010

(54) Apparatus for preventing using a device in an improper manner such as from too short a distance or for too much time

(76) Inventor: Michael Weibin Zhang, Yuen Long (HK)

Correspondence Address: ZHANG MICHAEL WEIBIN, 16/F FLAT D, BLK 1, SUN YUEN LONG CTR, YUEN LONG, NT, HK

(21) Appl. No.: 12/658,196

(22) Filed: Feb. 5, 2010

Related U.S. Application Data
(60) Provisional application No. 61/202,198, filed on Feb. 5, 2009.

(51) Int. Cl. G06F 21/00; G08B 21/00

(52) U.S. Cl. 340/679; 726/26

(57) ABSTRACT

An electronic apparatus with a CPU, a distance sensor and interfaces is attached to a host device with one or more screens. When a user uses the HD in an improper way such as too close or for excessive time, the apparatus will alert the user in a progressive way, and turn off the host device if the user does not correct his action. The apparatus can work with different host devices including TV, PC, video game console, handheld game console by means of remote control or via host devices' interfaces.

### CROSS REFERENCE TO RELATED APPLICATIONS

This application is based on and claims the priority of provisional patent application No. 61/202,198 filed Feb. 5, 2009.

### TECHNICAL FIELD

This application relates generally to health protection devices. More particularly, the application relates to accessories to work with electronic devices with one or more display screens to prevent using the devices in an improper manner such as from too short a distance or for too much time.

### BACKGROUND

More and more electronic devices with color display screens of different sizes, such as television set, computer, notebook computer, game console, hand-held game console, personal media player, mobile phone, are being used by children and adults for work, education, and entertainment. These devices can often provide interesting visual contents which are very entertaining to the users. Some users tend to use these devices for a too long period of time, resulting in fatigue, mismanagement of time, and even addiction. Some users, particularly children, tend to use the devices too close to their eyes, creating risks of getting Myopia.

This application describes apparatuses to work with one or many of these devices to alert the users or turn off the power of the devices when they are too close to the devices or using the devices for an excessive long period of time, and to help managing the time spent on these devices.

A single apparatus according to the present invention can work with different kinds of devices when set to the proper working mode. The apparatus can control the device without disconnecting the electrical power source for the device. Both distance and time information are measured, stored and used for better management of the user's health.

### SUMMARY OF THE INVENTION

An electronic apparatus according to the present invention is attached to the Host Device (HD) with one or more screens. When the user uses the HD in an improper way such as too close or for excessive time, the apparatus will alert the user in a progressive way, and/or turn off the HD if the user does not follow the instructions.

Referring to FIG. 1, an electronic apparatus according to the present invention comprises: a CPU Module, a Setup Module, a Display Module, a Distance Sensor Module, an Alarm Module, an HD Status Detection Module, and an HD Power Control Module.

Said Setup Module and Display Module allows the user to set a minimum distance and a time limit for each session or each day for using the HD. Said Distance Sensor Module senses if a user is present in front of the HD and the distance between the user and the HD. Said HD Status Detection Module detects if the HD is powered on, powered off or in stand by mode. Said CPU module accepts the data from said Distance Sensor Module and said HD Status Detection Module and calculates the distance and time, checks against the settings to decide if the user is too close to the HD's screen or using the HD for too long. If so, said CPU module will output a control signal to drive said Alarm Module to alert the user in a progressive way. Said Alarm Module has different alerting methods including but not limited to sound, light, and vibration.

Said HD Power Control Module can turn off the power of the HD after a certain period of time if the user does not comply with the warning.

Said HD Power Control Module includes different methods to control the power of the HD including but not limit to infrared remote control, wireless remote control, shutdown command issued via HD's I/O interface, HD power source disconnection, HD battery disconnection, and HD power circuit control.

Said Distance Sensor Module includes but not limits to infrared, ultrasound, and video imaging technologies.

Said HD Status Detection Module includes circuits to detect the wireless radio signal emitted from the working HD. Other methods to detect if the HD is in operation include but not limit to sensing the current change of the power cord of the HD, sensing the sound, vibration and display of the HD, and detecting the voltage changes on or accepting the information from the interfaces of the HD.

Said CPU module has I/O interfaces compatible with the HD to exchange information with the HD for HD status detection and HD power control.

Said CPU module connects to a flash Memory Card Slot for recording user's usage and settings in an external memory card.

Said CPU module connects to an I/O interface such as a USB Socket for connection with a computer or other external device to exchange data such as user settings and usage information.

These and other aspects of the invention are described below in the detailed description of the preferred embodiments.

### BRIEF DESCRIPTION OF THE DRAWINGS

FIG. 1 is a block diagram showing the modules of the present invention.

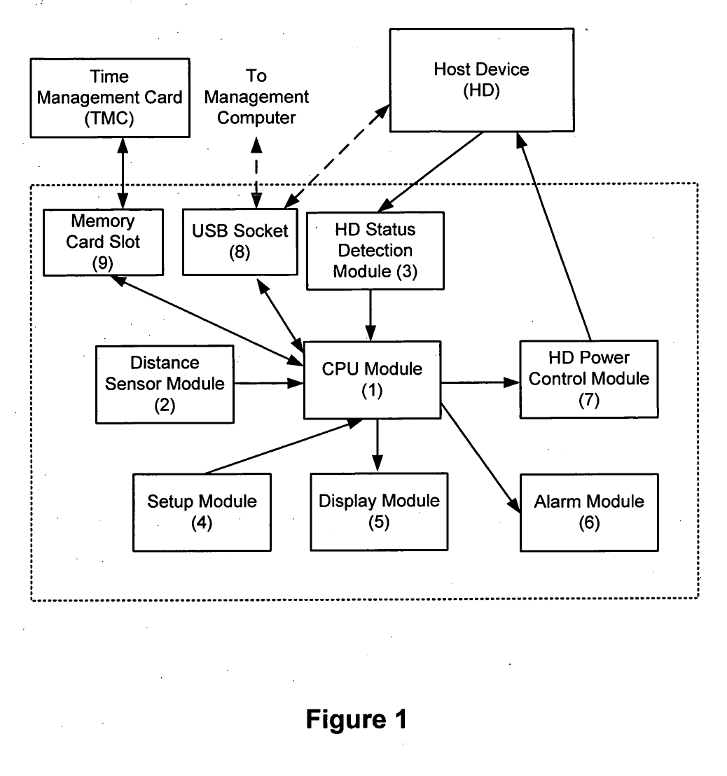

FIG. 2 is a block diagram showing the structure of a preferred embodiment for multiple purposes for the present invention.

FIG. 3 is a block diagram showing the structure of a preferred embodiment for use with handheld game consoles for the present invention.

FIG. 4 is a block diagram showing the structure of a preferred embodiment to be embedded with a host device for the present invention.

### DETAILED DESCRIPTION OF THE INVENTION

The present invention is an innovative system to help people use their electronic devices in a healthy way. The apparatuses according to the preset invention work with users' electronic devices to manage user's behavior. The user behavior information is directly fed or stored in memory cards first then transferred to a personal computer running corresponding software for further monitoring and management.

One preferred embodiment of the current invention is for multiple purposes. A single apparatus is designed to work with different kinds of HDs, one at a time, to prevent the user from being too close to the HD and/or using the HD for too long. The apparatus can work with HDs such as television set, desktop computer, notebook computer, and even for writing.

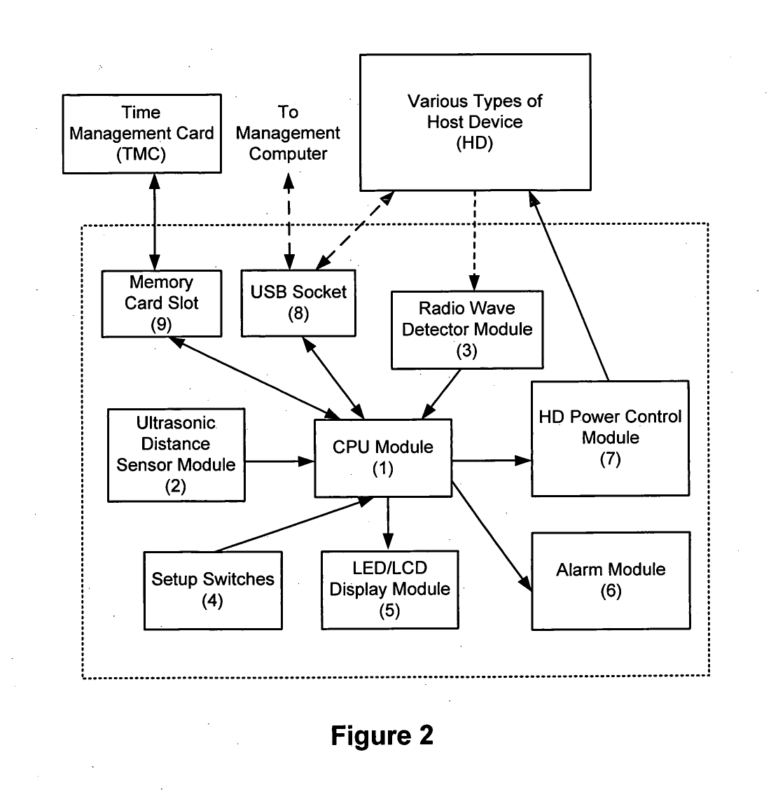

Referring to FIG. 2, the apparatus complies with: a CPU Module (1), an Ultrasonic Distance Sensor Module (2), a Radio Wave Detector Module (3), a set of Setup Switches (4), an LED/LCD Display Module (5), an Alarm Module (6), an HD Power Control Module (7), a USB Socket (8), and a Memory Card Slot (9).

The apparatus is installed next to the HD and facing the user. The CPU module (1) accepts the HD status signal from the Radio Wave Detector Module (3). The Radio Wave Detector Module (3) detects the radio waves emitted from the HD when power on to determine its status. When the HD turns on, the CPU Module (1) receives a signal from the Radio Wave Detector Module (3) and starts its internal timer, and at the same time activates the Ultrasonic Distance Sensor Module (2).

The CPU Module (1) accepts the distance sensing signal from the Ultrasonic Distance Sensor Module (2), and calculates the distance between the user and the apparatus. The Ultrasonic Distance Sensor Module (2) uses ultrasonic technology with an accuracy of less than 1 cm and a range up to 3 meters. This accuracy allows the CPU Module (1) to judge if the object detected is the user, someone walking by or environmental. If the distance of the user is less than the preset distance, the CPU Module (1) will send a signal to the Alarm Module (6) to sound a warning beep or generate a voice message to alert the user to keep a distance from the HD. Flashing light and vibrator can also be used in the Alarm Module to warn the user in different environment.

When the internal timer approaches the preset session limit, the apparatus will sound warning beeps and flash warning lights. When the internal timer reaches the preset session limit, the CPU Module (1) will control the HD Power Control Module (7) to send a remote control signal to the HD, in case of a television; or to send a ‘Shutdown’ keyboard command to the HD via a USB port, in case of a computer.

The Setup Switches (4) and the LED/LCD Display Module (5) are used to preset parameters such as minimum distance and session time limit. A few sets of parameters can be preset to suit different HDs such as television (longer distance) and PC (shorter distance). When placed on a desk facing the user's head, the apparatus can be used to prevent children from writing in an improper gesture such as being too close, uneven of the head or bending of the back.

The LED/LCD Display Module (5) uses LED/LCD digit display and can serve as a digital clock. The LED/LCD display also displays the elapsed time of the session.

The CPU Module (1) also accumulates the usage for each day. Daily limit can also be set. When the daily limit is reach, the CPU Module (1) can also issue warnings and turn off the HD.

Via the Memory Card Slot (9), usage and setting information can be transferred and stored in a flash memory card called the Time Management Card (TMC). One use of the TMC is to allow a few compatible apparatuses according to the current invention to work together for a few users in a household. Each user has his/her own Time Management Card with a unique internal ID, usage history, and settings. Whenever the user wants to use an HD, he/she is required to insert the TMC to the apparatus to activate the HD.

Another use of the Time Management Card is for it to act as a security key for authorized change of settings. Parents can keep the card away from the children to prevent the children from changing the settings themselves.

The CPU Module (1) connects to a USB Port (8) for communication with a computer or other external device to exchange data such as user settings and usage. Easy-to-use software on the computer can view, modify and save the user data. Comprehensive time management can be done by the software such as balancing between playing and studying for school children. The Time Management Card can also be used as the medium between the computer and the apparatus.

This embodiment serves multiple purposes and is suitable for HDs with different screen sizes and viewing distance to prevent the user from using the HD too close or for too long, reducing the user's risk of getting Myopia, mismanagement of time, and getting addicted to some kinds of entertainment such as video games.

Another embodiment of the current invention is for use with a certain type of handheld game console (HD) such as a model in the Nintendo DS series or the Sony PSP series.

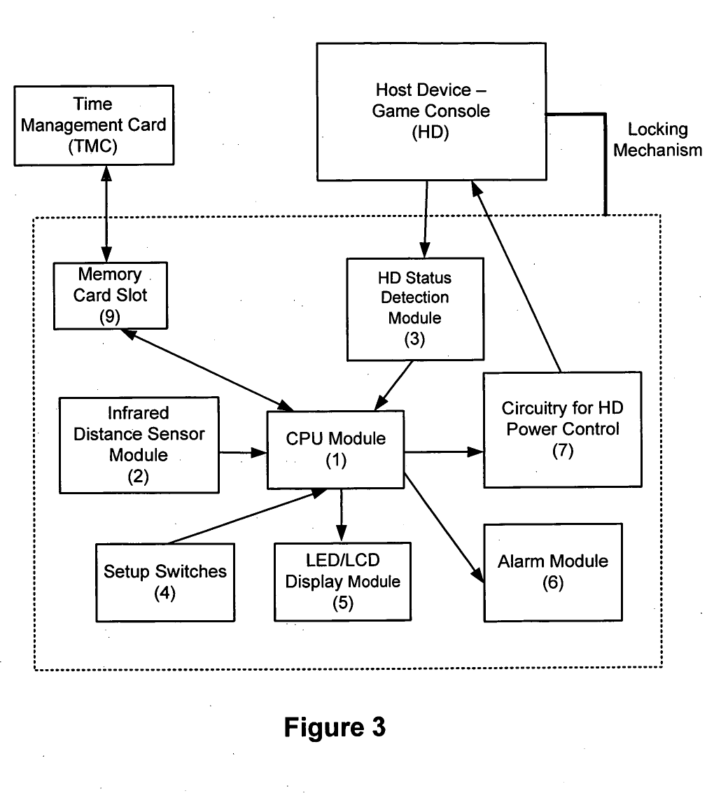

Referring to FIG. 3, this embodiment complies with: a CPU Module (1), an infrared Distance Sensor Module (2), an HD Status Detection Module (3), a set of Setup Switches (4), an LED/LCD Display Module (5), an Alarm Module (6), and Circuitry for HD Power Control (7), and a Memory Card Slot (9).

The Setup Switches (4) serve as inputs for the CPU Module (1) to determine the safe distance and the time limits.

When installed next to the screen of the game console, the infrared Distance Sensor Module (2) uses active infrared technology to detect the distance between the user's face and the game console which is within the range of 50 cm. When the distance detected is less than the preset safe distance, the CPU Module (1) will drive the Alarm Module (6) to sound warning beeps, vibrate and flash warning lights. If the user does not move a way to keep clear of the safe distance, the warning will continue on for a certain period of time before the CPU Module (1) drives the Circuitry for HD Power Control (7) to shutdown the game console.

The HD Status Detection Module (3) monitors the voltage changes of some pins of the game console's interfaces to determine the power status of the game console for ‘power on’, ‘power off’ or ‘stand by’. The power status information is used by the CPU Module (1) to start the timers.

The LED/LCD Display Module (5) displays the timer's reading and can use different colors to show if it is approaching to the end of the session or daily limit.

When the timer approaches the preset time limit, the CPU Module (1) will drive the Alarm Module (6) to sound warning beeps, vibrate and flash warning lights, to remind the user to save the game and take a rest. When the timer reaches the preset limit, the CPU Module (1) will control the HD Power Control Module (7) to shutdown the game console by controlling the power circuit of the game console via some pins of the game console's interfaces.

Once the time limit is reached, the user needs to turn off the game console or put it to stand by mode for a preset period of time before the timer is reset.

Game consoles are normally used by children. To prevent the apparatus from being taken off, a locking mechanism is used to secure the apparatus to the game console.

The Memory Card Slot (9) connecting to the CPU Module (1) is used to store settings and usage information in an external flash memory card for working with other compatible apparatuses or computers.

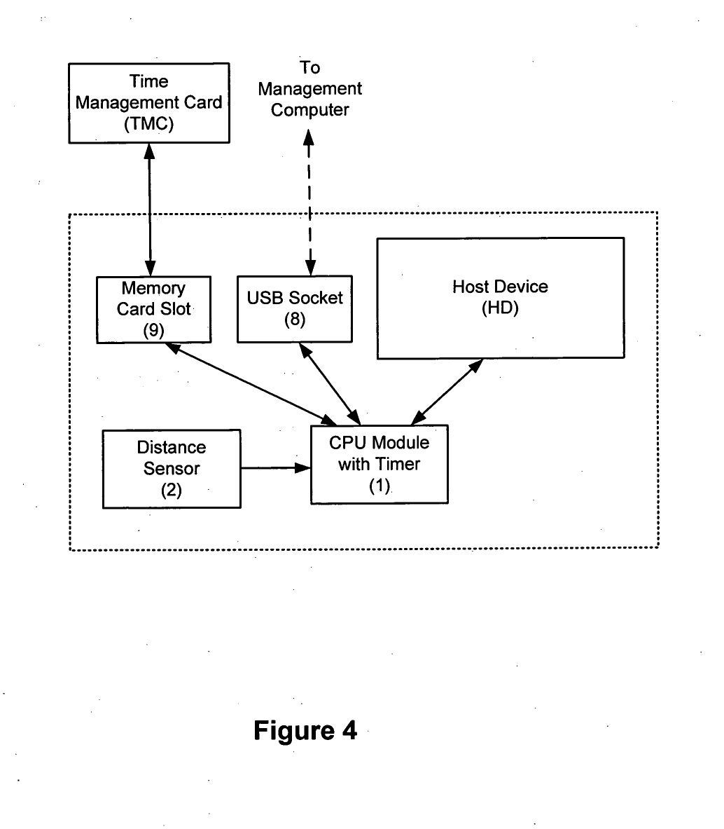

Yet another embodiment of the current invention is to incorporate the apparatus into the HD itself. Referring to FIG. 4, only the CPU Module (1) and the Distance Sensor Module (2) are essential besides the HD. As the HD is designed to work with the embodiment of the current invention, HD status detection and power control are done by I/O interfaces between the CPU Module (1) and the HD. Setup, display and alarm functions are also carried out by the HD's existing modules.

More and more entertainment rich electronic devices with color screens are used by people including children. Some of them may not be able to discipline themselves from excessive use. Many children tend to get too close to the screens unintentionally. The current invention helps the users to enjoy their electronic devices in a healthy way.

The present invention may be embodied in other specific forms without departing from its spirit or essential characteristics. The described embodiments are to be considered in all respects only as illustrative and not restrictive.

1. Apparatus for preventing using a host device (HD) in an improper manner such as from too short a distance or for too much time, including a CPU Module, a Distance Sensor Module as an input, and means of interfacing with the HD for detection and control of the HD.

2. Apparatus according to claim 1, in which said means of interfacing with the HD include a host device (HD) Status Detection Module, and an HD Power Control Module; said Distance Sensor Module including means for detecting the distance between a user and the HD; said CPU Module includes means for receiving the distance information from said HD Distance Sensor Module and the HD power status information from said HD Status Detection Module; said CPU Module includes means for determining the distance and time the user has spent on the HD; said CPU Module includes means for driving an Alarm Module to alert the user when the distance and time exceed the preset limits; said CPU Module includes means for controlling the HD via said HD Power Control Module.

3. Apparatus according to claim 1, further including: a Setup Module and a Display Module for presetting distance and time limits and displaying distance and time information.

4. Apparatus according to claim 1, in which said Distance Sensor Module includes infrared sensors or ultrasonic sensors for detecting the distance between the user and the HD.

5. Apparatus according to claim 2, in which said HD Status Detection Module includes means for determining if the HD's working status such as power on, off or standby.

6. Apparatus according to claim 2, in which said HD Power Control Module includes means for turning off the power of the HD when the user does not correct his improper action after being alerted.

7. Apparatus according to claim 3, in which said Alarm Module includes means of sound, voice, light, or vibration for alerting the user.

8. Apparatus according to claim 1 or 2, including an external memory device interface for said CPU Module to store security or identification code, user usage information and preset limits in an external memory device to be shared by another apparatus according to claim 1 or 2, or by a personal computer.

9. Apparatus according to claim 1 or 2, including an interface for connection with a personal computer or other external devices to exchange user usage information and preset limits.

10. Apparatus according to claim 8 or 9, in which said personal computer includes software to manage user usage information and preset limits.

11. Apparatus according to claim 5, in which said HD Status Detection Module includes means for sensing the HD's radio signal to determine HD's status.

12. Apparatus according to claim 5, in which said HD Status Detection Module includes means for detecting the HD's status via selected interfaces of the HD.

13. Apparatus according to claim 6, in which said HD Power Control Module includes means for controlling the power of the HD by infrared remote control or wireless remote control.

14. Apparatus according to claim 6, in which said HD Power Control Module includes means for controlling the HD via selected interfaces of the HD.
